(19) United States
(12) Patent Application Publication
(10) Pub. No.: US 2021/0104750 A1
(43) Pub. Date: Apr. 8, 2021

(54) NEGATIVE ELECTRODE FOR NONAQUEOUS ELECTROLYTE SECONDARY BATTERY, AND NONAQUEOUS ELECTROLYTE SECONDARY BATTERY

(71) Applicants: PANASONIC CORPORATION, Kadoma-shi, Osaka (JP); SANYO Electric Co., Ltd., Daito-shi, Osaka (JP)

(72) Inventors: Daisuke Ito, Hyogo (JP); Yuta Matsuo, Hyogo (JP); Kaori Ishikawa, Hyogo (JP)

(73) Assignees: PANASONIC CORPORATION, Kadoma-shi, Osaka (JP); SANYO Electric Co., Ltd., Daito-shi, Osaka (JP)

(21) Appl. No.: 16/498,189

(22) PCT Filed: Feb. 1, 2018
(86) PCT No.: PCT/JP2018/003375

§ 371 Date: Sep. 26, 2019

(30) Foreign Application Priority Data
Mar. 31, 2017 (JP) 2017-069833

(51) Int. Cl. H01M 4/66

(52) U.S. Cl. CPC H01M 4/663; H01M 2004/027; H01M 4/666; H01M 4/661

(57) ABSTRACT

A negative electrode includes a negative electrode current collector and a negative electrode mixture layer disposed on the current collector, the negative electrode mixture layer including a carbon material and a Si-containing compound. The negative electrode mixture layer includes a lower layer (a first layer) disposed on the negative electrode current collector, and an upper layer (a second layer) disposed on the lower layer. The lower layer includes the carbon material, the Si-containing compound, and a first binder including a polyacrylic acid or a salt thereof. The upper layer includes the carbon material and a second binder. The mass of the lower layer is not less than 50 mass % and less than 90 mass % of the mass of the negative electrode mixture layer, and the mass of the upper layer is more than 10 mass % and not more than 50 mass % of the mass of the negative electrode mixture layer.

### TECHNICAL FIELD

The present disclosure relates to a negative electrode for nonaqueous electrolyte secondary batteries, and a nonaqueous electrolyte secondary battery.

### BACKGROUND ART

Si-containing compounds such as silicon oxides SiOₓ are known to be capable of adsorbing more lithium ions per unit volume than carbon active materials such as graphites. For example, Patent Literature 1 discloses a nonaqueous electrolyte secondary battery which includes a silicon oxide as a negative electrode active material and uses polyacrylic acid as a binder in a negative electrode mixture layer. Si-containing compounds show a large volume change during charging and discharging as compared to graphites. Thus, it is proposed that Si-containing compounds are used in combination with graphites to attain a high battery capacity while maintaining good cycle characteristics.

### CITATION LIST

### Patent Literature

PTL 1: Japanese Published Unexamined Patent Application No. 2000-348730

### SUMMARY OF INVENTION

As mentioned above, a negative electrode which includes a Si-containing compound as a negative electrode active material exhibits a large volume change during charging and discharging. This fact causes a capacity deterioration after charging and discharging cycles. Specifically, a large volume change of a Si-containing compound during charging and discharging will result in a weakening or loss of contacts among the active material particles, and more active material particles will be isolated from the conductive paths in the negative electrode mixture layer to accelerate the capacity deterioration. A possible approach to preventing the isolation of Si-containing compound is to increase the amount of a binder. However, adding more binder decreases the input characteristics of negative electrodes.

An object of the present disclosure is to provide a high-capacity negative electrode which includes a Si-containing compound and allows a nonaqueous electrolyte secondary battery to attain excellent input characteristics while maintaining good cycle characteristics.

A negative electrode for nonaqueous electrolyte secondary batteries according to an aspect of the present disclosure includes a current collector and a mixture layer disposed on the current collector, the mixture layer including a carbon material and a Si-containing compound as active materials. In the negative electrode for nonaqueous electrolyte secondary batteries, the mixture layer includes a first layer which is disposed on the current collector and includes the carbon material, the Si-containing compound, and a first binder including a polyacrylic acid or a salt thereof, and a second layer which is disposed on the first layer and includes the carbon material and a second binder. The mass of the first layer is not less than 50 mass % and less than 90 mass % of the mass of the mixture layer, and the mass of the second layer is more than 10 mass % and not more than 50 mass % of the mass of the mixture layer.

A nonaqueous electrolyte secondary battery according to an aspect of the present disclosure includes the above negative electrode for nonaqueous electrolyte secondary batteries, a positive electrode, and a nonaqueous electrolyte.

With the negative electrode according to one aspect of the present disclosure, a high-capacity nonaqueous electrolyte secondary battery may be provided which exhibits excellent input characteristics yet has good cycle characteristics. Further, the nonaqueous electrolyte secondary battery according to one aspect of the present disclosure generates less gas during storage at high temperatures.

### BRIEF DESCRIPTION OF DRAWINGS

FIG. 1 is a perspective view of a nonaqueous electrolyte secondary battery according to an embodiment.

FIG. 2 is a sectional view of a negative electrode according to an embodiment.

### DESCRIPTION OF EMBODIMENTS

In high-capacity nonaqueous electrolyte secondary batteries which use a negative electrode including a Si-containing compound, an important challenge is to realize excellent input characteristics while keeping good cycle characteristics. The present inventors carried out extensive studies focusing on this challenge. As a result, the present inventors have developed a negative electrode that includes a negative electrode mixture layer composed of a first layer including a carbon material, a Si-containing compound, and a first binder including a polyacrylic acid or a salt thereof, and a second layer including a carbon material and a second binder. With this negative electrode, the present inventors have been successful in obtaining a nonaqueous electrolyte secondary battery which exhibits excellent input characteristics and still has a reduced capacity deterioration due to the swelling and shrinkage of an electrode assembly stemming from the Si-containing compound. As described above, the first layer is disposed on a negative electrode current collector and has a mass of not less than 50 mass % and less than 90 mass % relative to the mass of the mixture layer, and the second layer is disposed on the first layer and has a mass of more than 10 mass % and not more than 50 mass % relative to the mass of the mixture layer.

In the first layer which includes a Si-containing compound and a polyacrylic acid or a salt thereof, the isolation of the active material particles stemming from a large volume change of the Si-containing compound can be suppressed by the polyacrylic acid or salt thereof, and thus the battery will maintain good cycle characteristics. Preferably, the second layer does not substantially contain a Si-containing compound. By configuring the second layer disposed on the first layer so that it includes a carbon material and a second binder and is substantially free from a Si-containing compound, input characteristics may be enhanced and the generation of gas during storage at high temperatures in the charged state may be lessened. The polyacrylic acid or salt thereof offers the above effects when added to the first layer, and is preferably substantially absent in the second layer to attain enhancements in output characteristics.

In the present specification, the numerical ranges written as “(value 1) to (value 2)” mean that the value is not less than (value 1) and not more than (value 2).

Hereinbelow, embodiments of the nonaqueous electrolyte secondary batteries according to the present disclosure will be described in detail. A nonaqueous electrolyte secondary battery 10 according to an embodiment is a prismatic battery having a prismatic metallic case. However, the nonaqueous electrolyte secondary batteries of the present disclosure are not limited to such batteries, and may be other shapes such as, for example, cylindrical batteries having a cylindrical metallic case, and laminate batteries having an exterior case made of an aluminum laminate sheet or the like. The electrode assembly which constitutes the nonaqueous electrolyte secondary battery will be illustrated as a stacked electrode assembly 11 in which a plurality of positive electrodes and a plurality of negative electrodes are alternately stacked on top of one another via separators. However, the electrode assembly is not limited thereto and may be a wound electrode assembly in which a positive electrode and a negative electrode are wound via a separator.

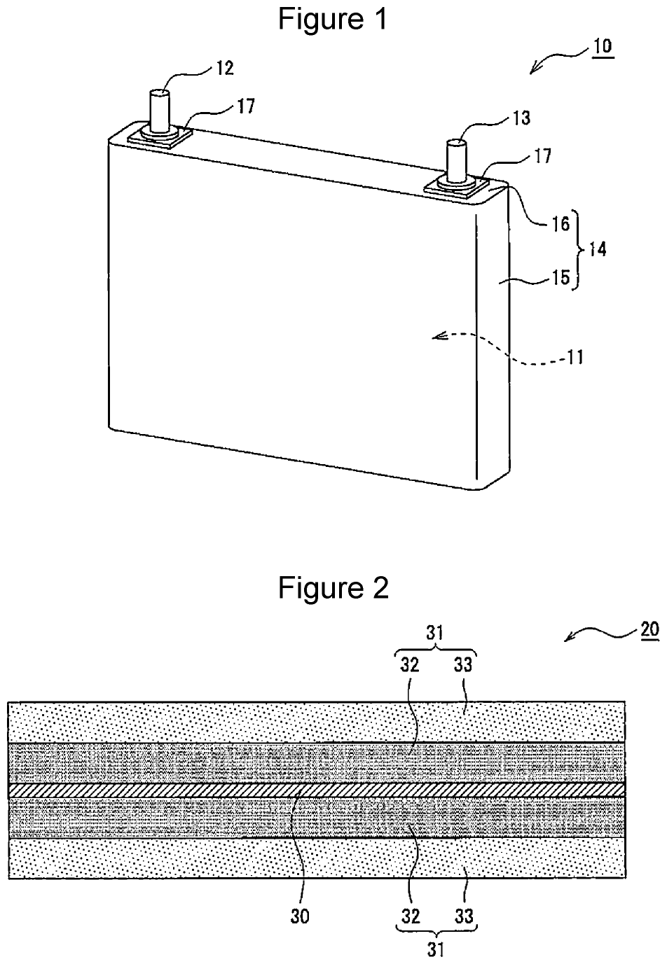

FIG. 1 is a perspective view illustrating the nonaqueous electrolyte secondary battery 10 according to an embodiment. The nonaqueous electrolyte secondary battery 10 includes an electrode assembly 11 having a stack structure, a nonaqueous electrolyte (not shown), and a battery case 14. The electrode assembly 11 includes positive electrodes, negative electrodes 20 and separators. The positive electrodes and the negative electrodes 20 are stacked alternately on top of one another via the separators. The negative electrodes 20, which will be discussed in detail later, have a mixture layer including a carbon material and a Si-containing compound as active materials.

The nonaqueous electrolyte includes a nonaqueous solvent and an electrolyte salt dissolved in the nonaqueous solvent. The nonaqueous electrolyte is not limited to a liquid electrolyte (a nonaqueous electrolytic solution), and may be a solid electrolyte such as a gel polymer. Examples of the nonaqueous solvents include esters such as ethylene carbonate (EC), dimethyl carbonate (DMC), ethyl methyl carbonate (EMC), diethyl carbonate (DEC) and methyl propionate (MP), ethers, nitriles, amides, and mixtures of two or more kinds of these solvents. The nonaqueous solvent may be a halogenated solvent resulting from the substitution of the above solvent with a halogen atom such as fluorine in place of at least part of hydrogen. For example, the electrolyte salt may be a lithium salt such as LiBF₄ or LiPF₆.

The battery case 14 is composed of a substantially box-shaped case body 15, and a seal body 16 which covers the opening of the case body 15. For example, the case body 15 and the seal body 16 are made of a metal material based on aluminum. The structure of the battery case 14 may be conventional.

The seal body 16 is provided with a positive electrode terminal 12 electrically connected to the respective positive electrodes, and a negative electrode terminal 13 electrically connected to the respective negative electrodes. To the positive electrode terminal 12, positive electrode lead portions that are exposed portions of the surface of positive electrode current collectors are connected directly or via other conductive members. To the negative electrode terminal 13, negative electrode lead portions that are exposed portions of the surface of negative electrode current collectors 30 are connected directly or via other conductive members.

The seal body 16 has through-holes which are not shown on both lateral sides, and the positive electrode terminal 12 and the negative electrode terminal 13, or the conductive members connected to these terminals, are inserted into the battery case 14 through these holes. For example, the positive electrode terminal 12 and the negative electrode terminal 13 are fixed to the seal body 16 via insulating members 17 arranged at the through-holes. The seal body 16 generally has a gas vent mechanism (not shown).

Hereinbelow, the constituents (the positive electrodes, the negative electrodes 20, and the separators) of the electrode assembly 11 will be described in detail, with a particular emphasis placed on the negative electrodes 20.

### [Positive Electrodes]

The positive electrode includes a positive electrode current collector and a positive electrode mixture layer disposed on the current collector. The positive electrode current collector may be, for example, a foil of a metal that is stable at the positive electrode potentials, such as aluminum, or a film having such a metal as a skin layer. The positive electrode mixture layer includes a positive electrode active material, a conductive agent and a binder. The positive electrode mixture layer is generally formed on both sides of the positive electrode current collector. For example, the positive electrode may be fabricated by applying a positive electrode mixture slurry including components such as a positive electrode active material, a conductive agent and a binder onto the positive electrode current collector, drying the wet films, and rolling the coatings to form positive electrode mixture layers on both sides of the current collector.

The positive electrode active material is preferably a lithium transition metal oxide. The metal element that constitutes the lithium transition metal oxide is, for example, at least one selected from magnesium (Mg), aluminum (Al), calcium (Ca), scandium (Sc), titanium (Ti), vanadium (V), chromium (Cr), manganese (Mn), iron (Fe), cobalt (Co), nickel (Ni), copper (Cu), zinc (Zn), gallium (Ga), germanium (Ge), yttrium (Y), zirconium (Zr), tin (Sn), antimony (Sb), tungsten (W), lead (Pb) and bismuth (Bi). In particular, the oxide preferably contains at least one selected from Co, Ni, Mn and Al.

Examples of the conductive agents contained in the positive electrode mixture layers include carbon materials such as carbon black (CB), acetylene black (AB), Ketjen black and graphite. Examples of the binders contained in the positive electrode mixture layers include fluororesins such as polytetrafluoroethylene (PTFE) and polyvinylidene fluoride (PVdF), polyacrylonitriles (PAN), polyimide resins, acrylic resins and polyolefin resins. These materials may be used singly, or two or more may be used in combination.

### [Negative Electrodes]

FIG. 2 is a sectional view of a negative electrode 20 according to an embodiment. As illustrated in FIG. 2, the negative electrode 20 includes a negative electrode current collector 30, and a negative electrode mixture layer 31 disposed on the current collector. The negative electrode current collector 30 may be, for example, a foil of a metal that is stable at the potentials of the negative electrode 20, such as copper, or a film having such a metal as a skin layer. The negative electrode mixture layer 31 includes negative electrode active materials and a binder. The negative electrode active materials include a carbon material and a Si-containing compound. For example, the negative electrode 20 may be fabricated by applying a negative electrode mixture slurry including negative electrode active materials, a binder, etc., onto the negative electrode current collector 30, drying the wet films, and pressing the coatings to form negative electrode mixture layers on both sides of the current collector.

The negative electrode mixture layer 31 has a two-layer structure which is composed of a lower layer 32 (a first layer) disposed on the negative electrode current collector 30, and an upper layer 33 (a second layer) disposed on the lower layer 32. The lower layer 32 includes a carbon material (a first carbon material), a Si-containing compound, and a first binder including a polyacrylic acid (PAA) or a salt thereof. The upper layer 33 includes a carbon material (a second carbon material) and a second binder. For example, the lower layer 32 is formed on the entirety of the negative electrode current collector 30 except a region to which a negative electrode lead will be connected, and the upper layer 33 is formed on the entirety of the lower layer 32.

The lower layer 32 includes a Si-containing compound. To suppress the isolation of active material particles, the lower layer 32 includes a first binder including a PAA or a salt thereof, and the amount of the first binder is preferably relatively large. In the upper layer 33, the amount of the binder is preferably small to attain enhanced input characteristics. That is, the content (mass %) of the binder in the lower layer 32 is preferably higher than the binder content in the upper layer 33. By forming the negative electrode mixture layer 31 as a two-layer structure, the amount of the binder in the upper layer 33 may be reduced and enhancements in input characteristics may be obtained.

During initial charging, an SEI film is formed on the surface of a negative electrode active material. This film serves to suppress side reactions between the active material and an electrolytic solution. A Si-containing compound significantly changes its volume during charging and discharging, and thus the surface of the active material tends to be newly exposed from the SEI film after the initial charging and discharging. Such newly exposed surface portions will undergo side reactions with an electrolytic solution to cause a large amount of gas to be generated. In the negative electrode 20, the upper layer 33 covers the lower layer 32 to reduce the chance of contacts of the Si-containing compound with an electrolytic solution, thus lessening the generation of gas.

The lower layer 32 represents not less than 50 mass % and less than 90 mass % of the mass of the negative electrode mixture layer 31. The upper layer 33 represents more than 10 mass % and not more than 50 mass % of the mass of the negative electrode mixture layer 31. The mass proportions of the lower layer 32 and the upper layer 33 may be each 50 mass %, and these layers may have substantially equal thicknesses. By limiting the mass proportion of the upper layer 33 to more than 10 mass % and not more than 50 mass %, excellent input characteristics may be realized while maintaining good cycle characteristics. If the mass proportion of the upper layer 33 is 10 mass % or less, good input characteristics are not obtained. If the upper layer 33 represents more than 50 mass %, the amount of the Si-containing compound in the lower layer 32 is relatively reduced to make it difficult to attain an increased capacity of the battery.

For example, the thickness of the negative electrode mixture layers 31 is 30 μm to 100 μm per side of the negative electrode current collector 30, and is preferably 50 μm to 80 μm. The thicknesses of the lower layer 32 and the upper layer 33 may be similar as long as the upper layer 33 does not surpass the lower layer 32 in thickness.

The lower layer 32 and the upper layer 33 each contain a carbon material as a negative electrode active material. Examples of the carbon materials as the negative electrode active materials include graphites and amorphous carbons, with graphites being preferable. Examples of the graphites include natural graphites such as flake graphite, massive graphite and earthy graphite, and artificial graphites such as massive artificial graphite (MAG) and graphitized mesophase carbon microbeads (MCMB). The graphite is generally secondary particles formed of a number of primary particles aggregated together. The average particle size of the graphite particles (secondary particles) is, for example, 1 μm to 30 μm. The average particle size of the graphite particles is the volume median diameter (Dv50) at 50% cumulative volume in a grain size distribution measured by a laser diffraction scattering method.

The carbon materials contained as the negative electrode active materials in the lower layer 32 and the upper layer 33 may be the same as each other, but preferably differ between the lower layer 32 and the upper layer 33. For example, the lower layer 32 may contain a carbon material capable of easing the volume change of the Si-containing compound, and the upper layer 33 may contain a carbon material which has good lithium ion acceptability and offers superior input characteristics. The carbon materials may be used singly, or two or more may be used in combination. The lower layer 32 may contain two kinds of carbon materials, and the upper layer 33 may contain a single carbon material.

Specifically, the carbon material (the first carbon material) contained in the lower layer 32 may be one having a tap density of 0.85 g/cm³ to 1.00 g/cm³, and is preferably a graphite having a tap density in the above range. For example, the carbon material (the second carbon material) contained in the upper layer 33 is one having a tap density of not less than 1.10 g/cm³, and is preferably a graphite having a tap density of 1.10 g/cm³ to 1.25 g/cm³. The tap density of the carbon material is the bulk density of a sample powder in a container after being tapped 250 times in accordance with JIS Z-2504.

From the above, it is preferable that the lower layer 32 and the upper layer 33 contain carbon materials differing from each other in tap density, and the tap density of the first carbon material be lower than the tap density of the second carbon material. Good cycle characteristics and high input characteristics may be attained easily when the first carbon material with a lower tap density is used in the lower layer 32, and the second carbon material with a higher tap density is contained in the upper layer 33.

As already described, the lower layer 32 includes a first carbon material, a Si-containing compound, and a first binder including a PAA or a salt thereof. The combined use of the Si-containing compound with the first carbon material allows the lower layer 32 to attain a smaller volume change due to charging and discharging, thus resulting in enhanced cycle characteristics. The mass ratio of the first carbon material to the Si-containing compound is preferably first carbon material:Si-containing compound =95:5 to 70:30, and more preferably 95:5 to 80:20. For example, the content of the first binder is 0.5 mass % to 10 mass %, and preferably 1 mass % to 5 mass % of the mass of the lower layer 32.

The Si-containing compound is not particularly limited as long as the compound contains Si. A silicon oxide represented by SiOₓ (0.5×1.5) is preferable. The Si-containing compounds may be used singly, or two or more may be used in combination. Preferably, the surface of SiOₓ particles is coated with a conductive film which is formed of a material having higher conductive properties than SiOₓ. The median diameter (Dv50) of SiOₓ is, for example, 1 μm to 15 μm, and is smaller than the Dv50 of the graphite particles.

For example, SiOₓ has a structure in which Si is dispersed in an amorphous SiO₂ matrix. The presence of dispersed Si may be confirmed by observing a cross section of a SiOₓ particle with a transmission electron microscope (TEM). SiOₓ may include lithium silicate (for example, lithium silicate represented by Li_{2z}SiO_{(2+z)} (0<z<2) within the particles, and may have a structure in which Si is dispersed in lithium silicate phases.

The conductive film is preferably a carbon film. For example, the carbon film is formed with a mass ratio of 0.5 mass % to 10 mass % relative to the mass of the SiOₓ particles. The carbon film may be formed by, for example, mixing the SiOₓ particles with coal tar or the like and heat treating the mixture, or may be formed by chemical vapor deposition (CVD) using a hydrocarbon gas or the like. Alternatively, the carbon film may be formed by attaching carbon such as carbon black or Ketjen black onto the surface of SiOₓ particles with use of a binder.

The first binder contained in the lower layer 32 may be exclusively a PAA or a salt thereof (for example, lithium salt, sodium salt, potassium salt or ammonium salt, or partially neutralized salt), but preferably further includes an additional binder. Examples of such additional binders include carboxymethylcellulose (CMC) and salts thereof, styrene-butadiene rubber (SBR), polyvinyl alcohol (PVA), polyethylene oxide (PEO), and derivatives thereof.

The proportion of the PAA or salt thereof in the first binder is at least 20 mass %, and preferably not less than 30 mass %. By using the PAA or salt thereof in the lower layer 32 including the Si-containing compound, the isolation of the active material particles stemming from a large volume change of the Si-containing compound can be suppressed, and the battery can maintain good cycle characteristics.

As described earlier, the upper layer 33 includes a second carbon material and a second binder. It is preferable that the upper layer 33 include the second carbon material as the only negative electrode active material and be substantially free from a Si-containing compound. For example, the content of a Si-containing compound in the upper layer 33 is less than 1 mass %. The content of the second binder is, for example, 0.5 mass % to 10 mass % of the mass of the upper layer 33, and is preferably 1 mass % to 5 mass %.

Examples of the second binders contained in the upper layer 33 include CMC and salts thereof, SBR, PVA, PEO, and derivatives thereof. Preferably, the upper layer 33 is substantially free from a PAA or a salt thereof. For example, the content of a PAA or a salt thereof in the upper layer 33 is less than 0.1 mass %.

### [Separators]

The separator may be a porous sheet having ion permeability and insulating properties. Specific examples of the porous sheets include microporous thin films, woven fabrics and nonwoven fabrics. Some preferred separator materials are olefin resins such as polyethylene, polypropylene, and copolymers including at least one of ethylene and propylene, and celluloses. The separator may be a stack having a cellulose fiber layer and a thermoplastic resin fiber layer such as of olefin resin. The separator may be a multilayer separator including a polyethylene layer and a polypropylene layer, and may have a coating layer including an aramid resin or the like on its surface. A heat resistant layer including an inorganic compound filler may be disposed in the interface(s) between the separator and at least one of the positive electrode and the negative electrode 20.

### EXAMPLES

Hereinbelow, the present disclosure will be further described based on EXAMPLES. However, it should be construed that the scope of the present disclosure is not limited to such EXAMPLES.

### Example 1

### [Positive Electrode]

A positive electrode mixture slurry was prepared by mixing 94.8 parts by mass of lithium transition metal oxide LiNi_{1/3}Co_{1/3}Mn_{1/3}O₂ as a positive electrode active material, 4 parts by mass of acetylene black (AB) and 1.2 parts by mass of polyvinylidene fluoride (PVdF), and adding an appropriate amount of N-methyl-2-pyrrolidone (NMP) to the mixture. Next, the positive electrode mixture slurry was applied to both sides of an aluminum foil as a positive electrode current collector except a region to which a lead would be connected. The wet films were dried and rolled with a roller. The sheet was then cut to a predetermined electrode size. Thus, a positive electrode was fabricated which had the positive electrode mixture layers on both sides of the positive electrode current collector.

### [Preparation of Negative Electrode Mixture Slurries]

A first negative electrode mixture slurry for forming lower layers (first layers) was prepared by mixing 89 parts by mass of graphite A having a tap density of 0.92 g/cm³, 8 parts by mass of carbon-coated SiOₓ (x=0.94), 1 part by mass of PAA lithium salt, 1 part by mass of CMC sodium salt and 1 part by mass of SBR, and adding an appropriate amount of water to the mixture. Separately, a second negative electrode mixture slurry for forming upper layers (second layers) was prepared by mixing 97.5 parts by mass of graphite A, 1.5 parts by mass of CMC sodium salt and 1 part by mass of SBR, and adding an appropriate amount of water to the mixture.

Next, the first negative electrode mixture slurry was applied to both sides of a copper foil as a negative electrode current collector except a region to which a lead would be connected. The wet films were dried to form lower layers on both sides of the current collector. Subsequently, the second negative electrode mixture slurry was applied to the lower layers on both sides of the current collector, and the wet films were dried to form upper layers. The coatings were then rolled with a roller, and the sheet was cut to a predetermined electrode size. Thus, a negative electrode was fabricated which had the negative electrode mixture layers, each including the lower layer and the upper layer, on both sides of the negative electrode current collector.

### [Preparation of Nonaqueous Electrolytic Solution]

Ethylene carbonate (EC) and ethyl methyl carbonate (EMC) were mixed in a volume ratio of 3:7. Lithium hexafluorophosphate (LiPF₆) was added to the above mixed solvent so that the concentration would be 1.0 mol/L. Further, 2 vol % (with respect to the solvents alone) of vinylene carbonate was added. A nonaqueous electrolytic solution was thus prepared.

### [Fabrication of Test Cell]

Leads were attached to the positive electrode and the negative electrode. The electrodes were wound together via a separator into a coil to give a wound electrode assembly. The separator used was a polypropylene monolayer separator. The electrode assembly was inserted into an exterior case composed of an aluminum laminate sheet, and was vacuum dried at 105° C. for 2 hours and 30 minutes. The nonaqueous electrolytic solution was poured into the case, and the open end of the exterior case was sealed. A test cell (a laminate cell) was thus fabricated. The design capacity of the test cell was 880 mAh.

### Example 2

A test cell was fabricated in the same manner as in EXAMPLE 1, except that the graphite A used in the preparation of the second negative electrode mixture slurry was replaced by graphite B having a tap density of 1.14 g/cm³.

### Comparative Example 1

A test cell was fabricated in the same manner as in EXAMPLE 1, except that in the fabrication of the negative electrode, negative electrode mixture layers were formed as single-layer structures by the application of a negative electrode mixture slurry which had been prepared by mixing graphite A, carbon-coated SiOₓ (x=0.94), PAA lithium salt, CMC sodium salt and SBR in a mass ratio of 93:4:1:1:1. The thickness of the negative electrode mixture layer was controlled to be substantially the same as the thickness of the negative electrode mixture layer (two-layer structure) of EXAMPLES 1 and 2.

The test cells of EXAMPLES and COMPARATIVE EXAMPLE were tested by the following methods to evaluate their performance. The evaluation results are described in Table 1.

### [Evaluation of Initial Charge Discharge Efficiency and Capacity Retention Ratio]

At a temperature of 25° C., the test cell was charged at a constant current of 0.5 It to a cell voltage of 4.2 V, and was thereafter charged at a constant voltage of 4.2 V until the current value decreased to 1/50 It. Thereafter, the test cell was discharged at a constant current of 0.5 It to a cell voltage of 2.5 V. The charge capacity X and the discharge capacity Y1 in the above process were determined. The initial charge discharge efficiency was calculated from the following equation.

Initial charge discharge efficiency (%)=(Y1/X)×100

The above charge discharge cycle was repeated 50 times. The discharge capacity Y2 in the 50th cycle was measured. The capacity retention ratio was calculated from the following equation.

Capacity retention ratio (%)=(Y2/Y1)×100

In Table 1, the capacity retention ratios of the EXAMPLE test cells are shown as values relative to the capacity retention ratio of the test cell of COMPARATIVE EXAMPLE 1 taken as 1.00.

### [Evaluation of Input Characteristics]

At a temperature of 25° C., the test cell was charged at a constant current of 0.5 It to half the initial capacity. The charging was discontinued, and the cell was allowed to stand for 15 minutes. Thereafter, at a temperature of 25° C. or −30° C., the test cell was charged at a current of 0.1 It for 10 seconds, and the voltage was measured. The capacity charged in the 10 seconds was discharged, and the test cell was charged at the next value of current for 10 seconds and was measured for voltage. The capacity charged in the 10 seconds was discharged. This process was repeated while increasing the current value from 0.1 It to 2 It. Based on the voltage values measured, the current value at which the test cell would be charged to 4.2 V in 10 seconds was calculated, and the power required for such charging was determined.

### [Evaluation of Amount of Gas Generation During High-Temperature Storage in Charged State]

At a temperature of 25° C., the test cell was discharged at a constant current of 0.5 It to a cell voltage of 2.5 V and was thereafter charged at a constant current of 0.5 It to a cell voltage of 4.2 V. Next, the volume (V0) of the test cell was determined by the Archimedes method. The test cell was then allowed to stand at a temperature of 60° C. for 10 days, and the volume (V1) thereof was measured again. The amount of gas generation was calculated based on the following equation.

Amount of gas generation=V1−V0

The smaller the amount of gas generation, the higher the storage stability (stability during storage at high temperatures in charged state). In Table 1, the amounts of gas generation in the EXAMPLE test cells are shown as values relative to the amount of gas generation in the test cell of COMPARATIVE EXAMPLE 1 taken as 1.00.

TABLE 1

| | | Initial charge | Input | Input | Capacity | Amount |
|---|---|---|---|---|---|---|
| | | discharge | characteristics | characteristics | retention | of gas |
| | | efficiency | at 25° C. | at −30° C. | ratio | generation |
| EX. 1 | Upper layer: Graphite | 86.7% | 1.02 | 1.08 | 1.00 | 0.92 |
| | A/CMC/SBR | | | | | |
| | Lower layer: Graphite | | | | | |
| | A/SiOₓ/PAA/CMC/SBR | | | | | |
| EX. 2 | Upper layer: Graphite | 86.2% | 1.12 | 1.17 | 1.00 | 0.77 |
| | B/CMC/SBR | | | | | |
| | Lower layer: Graphite | | | | | |
| | A/SiOₓ/PAA/CMC/SBR | | | | | |
| COMP. | Single layer: Graphite | 86.3% | 1.00 | 1.00 | 1.00 | 1.00 |
| EX. 1 | A/SiOₓ/PAA/CMC/SBR | | | | | |

As shown in Table 1, the test cells of EXAMPLES 1 and 2 outperformed the test cell of COMPARATIVE EXAMPLE 1 in input characteristics. Further, the test cells of EXAMPLES 1 and 2 generated a small amount of gas during the high-temperature storage in the charged state and attained excellent storage characteristics, as compared to the test cell of COMPARATIVE EXAMPLE 1. In particular, marked improvements in input characteristics and storage characteristics were attained by the test cell of EXAMPLE 2 in which the graphite A with a lower tap density was used in the lower layers of the negative electrode mixture layers and the graphite B with a higher tap density was added to the upper layers. The test cells of EXAMPLES 1 and 2 compared equally to the test cell of COMPARATIVE EXAMPLE 1 in initial charge discharge efficiency and capacity retention ratio after 50 cycles.

### REFERENCE SIGNS LIST

10 NONAQUEOUS ELECTROLYTE SECONDARY BATTERY

11 ELECTRODE ASSEMBLY

12 POSITIVE ELECTRODE TERMINAL

13 NEGATIVE ELECTRODE TERMINAL

14 BATTERY CASE

15 CASE BODY

16 SEAL BODY

17 INSULATING MEMBER

20 NEGATIVE ELECTRODE

30 NEGATIVE ELECTRODE CURRENT COLLECTOR

31 NEGATIVE ELECTRODE MIXTURE LAYER

32 LOWER LAYER

33 UPPER LAYER

1. A negative electrode for nonaqueous electrolyte secondary batteries comprising a current collector and a mixture layer disposed on the current collector, the mixture layer including a carbon material and a Si-containing compound as active materials, wherein
the mixture layer comprises:
a first layer which is disposed on the current collector and includes the carbon material, the Si-containing compound, and a first binder comprising a polyacrylic acid or a salt thereof, and
a second layer which is disposed on the first layer and includes the carbon material and a second binder, and
the mass of the first layer is not less than 50 mass % and less than 90 mass % of the mass of the mixture layer, and the mass of the second layer is more than 10 mass % and not more than 50 mass % of the mass of the mixture layer.

2. The negative electrode for nonaqueous electrolyte secondary batteries according to claim 1, wherein the carbon materials contained in the first layer and the second layer differ from each other.

3. The negative electrode for nonaqueous electrolyte secondary batteries according to claim 2, wherein the carbon material contained in the first layer has a tap density of 0.85 g/cm³ to 1.00 g/cm³.

4. A nonaqueous electrolyte secondary battery comprising:
the negative electrode for nonaqueous electrolyte secondary batteries described in claim 1,
a positive electrode, and
a nonaqueous electrolyte.
